(19) United States
(12) Patent Application Publication
(10) Pub. No.: US 2017/0304864 A1
(43) Pub. Date: Oct. 26, 2017

(54) COATING APPARATUS FOR COLOR FILTER SUBSTRATE AND COATING METHOD THEREOF

(71) Applicants: BOE TECHNOLOGY GROUP CO., LTD., Beijing (CN); BEIJING BOE DISPLAY TECHNOLOGY CO., LTD., Beijing (CN)

(72) Inventors: Xiaoguang LI, Beijing (CN); Dong WANG, Beijing (CN); Jingjing JIANG, Beijing (CN); Yu XIAO, Beijing (CN)

(21) Appl. No.: 15/510,182

(22) PCT Filed: Mar. 7, 2016
(86) PCT No.: PCT/CN2016/075795

§ 371 Date: Mar. 9, 2017

(30) Foreign Application Priority Data
Sep. 10, 2015 (CN) 201510574035.0

(51) Int. Cl. B05C 9/10; G02F 1/1335; G02F 1/13; B05D 3/12; B05D 1/02; B05B 12/12; B24B 21/00; B05B 9/00

(52) U.S. Cl. CPC B05C 9/10; B24B 21/006; G02F 1/133516; G02F 1/1303; B05B 9/00; B05D 3/12; B05D 1/02; B05B 12/12; G02F 2001/133519

(57) ABSTRACT

A coating apparatus for a color filter substrate, including a coating sprayer (1) configured to coat a first film layer on a color filter layer (03) formed on the color filter substrate (01); a grinding device (2) configured to grind the color filter layer (03) to eliminate a step formed by the color filter layer (03) covering a black matrix (02); and a detection control unit (3) configured to measure a height of the step, determine a grinding amount of the grinding device (2) according to the height of the step, and control an operation of the grinding device (2) such that the first film layer coated on the color filter layer (03) has a flat surface. Also disclosed is a coating method for a color filter substrate.

### TECHNICAL FIELD

Embodiments of the present disclosure relate to a coating apparatus for a color filter substrate and a coating method thereof.

### BACKGROUND

A liquid crystal display is a panel display device consisting of a color filter substrate, an array substrate, as well as a liquid crystal layer and a Polyimide (PI) alignment layer packaged between the color filter substrate and the array substrate, in which the PI layer is usually sprayed onto a surface of the color filter substrate by using an inkjet device to allow liquid crystal molecules of the liquid crystal layer between the color filter substrate and the array substrate to be arranged according to a certain rule; the spraying process for the PI layer has higher demand on a flatness of the color filter substrate, and if the flatness of the color filter substrate is poor, it's likely to result in non-uniform coating and dispersion, and finally influences a display quality of the display device.

A sectional view of the color filter substrate in the prior art is illustrated in FIG. 1. Referring to FIG. 1, the color filter substrate includes a substrate 01, a black matrix 02, a color filter layer 03, a planarization layer 04 and a columnar spacer 05, in which the black matrix 02 includes plural black matrix units alternately disposed on a substrate 01 at certain intervals, a spacing region is formed between two adjacent black matrixes, the color filter layer 03 is disposed in the spacing region and extending to the black matrix units on both sides to be overlapped with the black matrix units, so as to effectively avoid light leakage at an edge of a sub-pixel; at this point, since the color filter layer 03 and the black matrix units overlap with each other, a top height of the color filter layer 03 in an overlapping region is increased to form a step of the color filter layer 03, which affects the flatness of the color filter substrate after the planarization layer 04 is sprayed, and thus affects the display quality of the display device.

### SUMMARY

Embodiments of the present disclosure provide a coating apparatus for a color filter substrate and a coating method thereof, which can grind off a step of a color filter layer, reduces a coating thickness and saves a coating cost.

At least one embodiment of the present disclosure provides a coating apparatus for a color filter substrate, including a coating sprayer configured to coat a first film layer on a color filter layer of the color filter substrate; a grinding device configured to grind the color filter layer to eliminate a step formed by the color filter layer covering a black matrix; and a detection control unit configured to measure a height of the step, determine a grinding amount of the grinding device according to the height of the step, and control an operation of the grinding device such that the first film layer coated on the color filter layer has a flat surface.

In the coating apparatus for a color filter substrate according to the embodiments of the present disclosure, the detection control unit can measure the height of the step formed by the color filter layer covering the black matrix, and can further determine the grinding amount of the grinding device according to the height of the step, which allows the first film layer coated on the color filter layer having a flat surface. In this way, by determining the grinding amount of the grinding device, controlling the operation of the grinding device according to the grinding amount to eliminate the step of the color filter layer, and then coating a first film layer on the color filter layer of the color filter substrate by using a coating sprayer, the flatness of the color filter substrate is improved.

Compared with the prior art, by adopting the coating apparatus for a color filter substrate according to the embodiments of the present disclosure to coat the first film layer, the step of the color filter layer can be removed, the flatness of the color filter substrate can be improved, a height of the color filter layer can be reduced by removing the step of the color filter layer, and a coating thickness of the first film layer is reduced, thus saving a consumption amount of the material and also the cost for coating.

At least one embodiment of the present disclosure further provides a coating method for a color filter substrate, including: measuring, by a detection control unit, a height of a step formed by a color filter layer formed on the color filter substrate covering a black matrix to obtain the height of the step, determining a grinding amount for the color filter layer according to the height of the step, and grinding the color filter layer at the grinding amount; and coating a first film layer on the color filter layer upon grinding.

### BRIEF DESCRIPTION OF THE DRAWINGS

Hereafter, the embodiments of the present invention will be described in a more detailed way with reference to the accompanying drawings, so as make one person skilled in the art be able to understand the present invention more clearly, wherein:

FIG. 1 is a schematic diagram of a sectional structure of a color filter substrate;

FIG. 2 is a schematically structural diagram of a coating apparatus for a color filter substrate according to an embodiment of the present disclosure;

FIG. 3 is a schematic diagram of a sectional structure of a first transfer device in a coating apparatus for a color filter substrate according to an embodiment of the present disclosure; and

FIG. 4 is a schematically structural diagram of a grinding device in a coating apparatus for a color filter substrate according to an embodiment of the present disclosure.

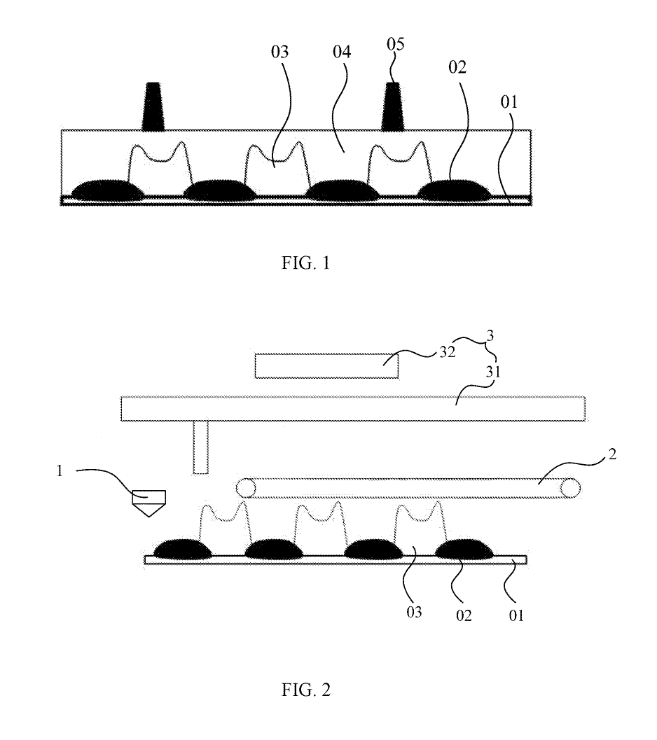

### DETAILED DESCRIPTION

In order to make one skilled person in the art better understand the technical solutions of the present disclosure, hereafter, a color filter substrate, display panel and display device of the present disclosure will be further described in detail with reference to the accompanying drawings and embodiments.

Unless otherwise defined, all the technical and scientific terms used herein have the same meanings as commonly understood by one of ordinary skill in the art to which the present invention belongs. The terms “first,” “second,” etc., which are used in the description and the claims of the present application for invention, are not intended to indicate any sequence, amount or importance, but distinguish various components. Also, the terms such as “a,” “an,” etc., are not intended to limit the amount, but indicate the existence of at least one. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly

Referring to FIG. 2, which is a schematically structural diagram of a coating apparatus for a color filter substrate according to an embodiment of the present disclosure. The coating apparatus for a color filter substrate includes: a coating sprayer 1 configured to coat a first film layer on a color filter layer 03 of a color filter substrate 01; a grinding device 2 configured to grind the color filter layer 03 to eliminate the step formed by the color filter layer 03 covering a black matrix 02; and a detection control unit 3 capable of controlling an operation of the grinding device 2, measuring a height of the step, and determining a grinding amount of the grinding device 2 according to the height of the step to allow the first film layer coated on the color filter layer 03 having a flat surface.

In the coating apparatus for a color filter substrate according to an embodiment of the present disclosure, the detection control unit 3 can measure the height of the step of the color filter layer 03 and can further determine the grinding amount of the grinding device according to the height of the step; in this way, the grinding amount of the grinding device 2 can be determined through the detection control unit 3, the operation of the grinding device 2 can be controlled according to the grinding amount to remove the step of the color filter layer 03, and then the coating sprayer 1 can be utilized to coat the first film layer on the color filter layer of the color filter substrate 01 to improve the flatness of the color filter substrate 01. By coating the first film layer using the above coating apparatus for a color filter substrate, as compared with the prior art, the step of the color filter layer 03 can be eliminated, the flatness of the color filter substrate can be improved, the height of the color filter layer 03 can be reduced due to the removal of the step of the color filter layer 03, and the coating thickness of the first film layer is reduced, thus saving a consumption amount of the material for the first film layer and reducing a coating cost of the first film layer.

In the embodiment of the present disclosure, the first film layer can be a planarization layer or an alignment film layer, which is not limited herein.

In order to realize the detection on the height of the step of the color filter layer 03 and realize the control over the grinding device 2. For example, as illustrated in FIG. 2, the detection control unit 3 can include an optical measuring system 31 and a control unit 32; the optical measuring system 31 can scan and photograph the color filter substrate to obtain an overall profile of the color filter layer 03; the control unit 31 is connected to the grinding device 2 and the optical measuring system 31 respectively; the control unit 32 obtains an average value of steps of the color filter layer 03 according to the overall profile of the color filter layer 03 to realize the detection on the height of the step of the color filter layer 03, determines the average value of the steps of the color filter layer 03 as a grinding amount of the grinding device 2, and further controls the grinding device 2 to grind the color filter layer 03 according to the determined grinding amount. In this way, the grinding amount can be determined precisely, thereby avoiding the problem that the step cannot be ground off due to insufficient grinding amount or the color filter layer 03 is made too thin caused by excessive grinding amount.

In order to enable the grinding device 2 to grind off the step formed by the color filter layer 03 covering the black matrix, referring to FIG. 3, the grinding device 2 includes a grinding cloth 21 and a first transfer device 22; the grinding cloth 21, serving as a grinding tool, can eliminate part of the step when contacting the step and making a relative movement with the step; and the first transfer device 22 enables the relative movement between the grinding cloth 21 and the step of the color filter layer 03, which movement is parallel with the color filter substrate.

In order to enable the relative movement between the grinding cloth 21 and the color filter substrate 03 in parallel with the color filter substrate so as to eliminate the step formed by the color filter layer 03 covering the black matrix, the grinding cloth 21 can be fixed while the color filter substrate is moved along a direction parallel with the grinding cloth 21, or the color filter substrate can be fixed while the grinding cloth 21 is moved along a direction parallel with the color filter substrate. When the former is adopted, all the steps on the color filter substrate can be ground off only if the color filter substrate is moved quickly and significantly, which involves larger movement space, higher movement frequency, higher energy consumption and lower efficiency. In order to avoid this problem, in an embodiment of the present disclosure, the color filter substrate is fixed, and the step is ground off by moving the grinding cloth 21 along a direction parallel with the color filter substrate. For example, a soft grinding cloth 21 can be sleeved on a rotary shaft, and the rotary shaft is driven to rotate to drive the grinding cloth 21 to grind circularly, so that the step of the color filter layer 03 can be ground off by only moving the rotary shaft sleeved with the grinding cloth 21 towards the color filter substrate to be in contact with the step of the color filter substrate, which involves smaller movement space, lower movement frequency, decreased energy consumption, larger rotary speed of the rotary shaft and improved grinding efficiency of the grinding cloth 21. In such case, the transfer device includes a first transfer device 22, which can drive the grinding cloth 21 to move along a direction parallel with the color filter substrate.

In an embodiment of the present disclosure, in order to drive the grinding cloth 21 to move along a direction parallel with the color filter substrate, the first transfer device 22 can include a single transfer shaft, and an axis of the transfer shaft is parallel with the color filter substrate; the grinding cloth 21 is wound around and fixed on the transfer shaft, and the transfer shaft is connected to a rotary motor which can drive the transfer shaft to rotate around an axis thereof, such that the grinding cloth 21 is driven to rotate around the axis and hence move along a direction parallel with the color filter substrate.

In an embodiment of the present disclosure, in order to drive the grinding cloth 21 to move along a direction parallel with the color filter substrate, the first transfer device 22 includes at least two transfer shafts disposed in parallel, and a plane where the at least two transfer shafts are located is parallel with the color filter substrate; the grinding cloth 21 is connected end to end to form an annular structure, then the grinding cloth 21 with the annular structure is sleeved on the at least two transfer shafts and is tensioned by the transfer shafts; at least one of the transfer shafts is connected to a rotary motor which can drive the transfer shaft to rotate around an axis thereof such that the grinding cloth 21 is driven to rotate around the transfer shaft.

Compared with the first transfer device including a single transfer shaft, the first transfer device 22 including two transfer shafts disposed in parallel can increase a grinding area of the grinding cloth 21, such that the grinding cloth 21 can grind all steps on the color filter substrate at the same time, and the grinding efficiency is improved to the greatest extent; moreover, with a plurality of transfer shafts, a tensile force of the grinding cloth 21 on the transfer shaft can be improved. Therefore, with the use of the first transfer shaft 22 including two transfer shafts disposed in parallel, it can improve the grinding efficiency and increase the tensile force. For example, as illustrated in FIG. 3, the first transfer device 22 includes two transfer shafts 221 disposed in parallel, and a plane where the two transfer shafts 221 are located is parallel with the color filter substrate 01; the grinding cloth 21 is connected end to end to form an annular structure, then the grinding cloth 21 with the annular structure is sleeved on the two transfer shafts 221 and is tensioned by the transfer shafts 221; one of the transfer shafts 221 is connected to a rotary motor 222 which can drive the transfer shaft 22 to rotate around an axis thereof, so as to drive the grinding cloth 21 to rotate around the transfer shaft 221; a plane between the two transfer shafts 221 is an effective grinding surface; when the color filter substrate is placed on a bearing platform 100 and located right below the grinding surface, a grinding region of the grinding cloth 21 can completely cover the upper surface of the color filter substrate, such that the grinding efficiency is improved to the greatest extent.

In an embodiment of the present disclosure, the color filter substrate can be placed manually right below the grinding surface. In another embodiment of the present disclosure, the color filter substrate can be conveyed to be right below the grinding surface through a conveyor belt. When the color filter substrate is placed manually right below the grinding surface, the process of placing-onto and taking-down spends much time and involves lower efficiency. By placing a plurality of color filter substrates on the conveyor belt at intervals and conveying the color filter substrate to be right below the grinding surface through the conveyor belt, the transfer time is saved and the transfer efficiency is improved.

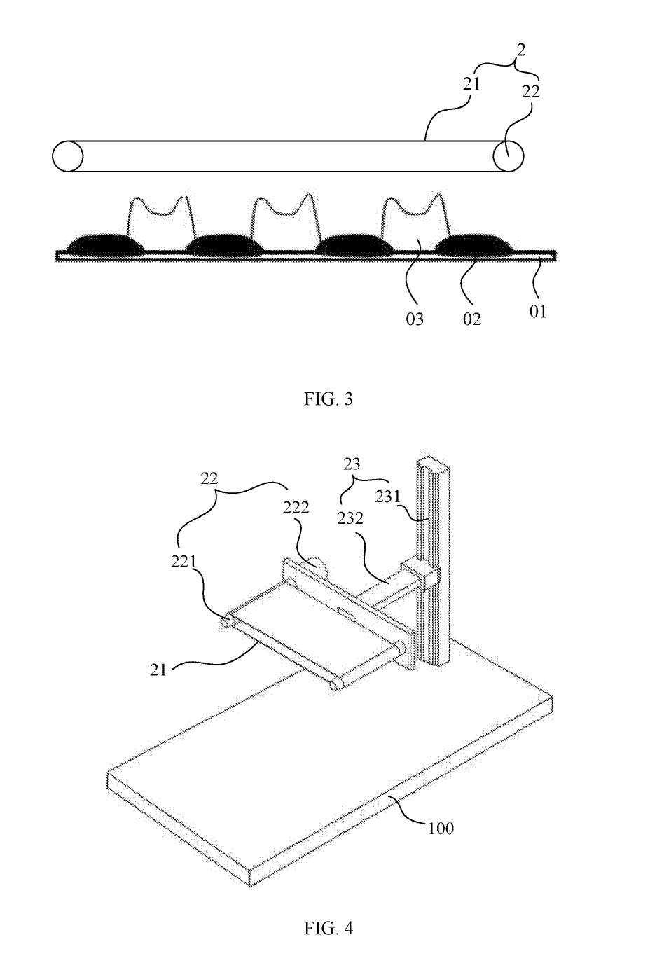

In order to realize feeding the grinding cloth, it's possible to cause the grinding cloth 21 to be contacted with the step of the color filter layer 03 for grinding. In an embodiment of the present disclosure, referring to FIG. 4, the grinding device 2 further includes a second transfer device 23, the second transfer device 23 can drive both the grinding cloth 21 and the first transfer device 22 to move along a direction perpendicular to the color filter substrate; during grinding operation, the second transfer device 23 can drive the grinding cloth 21 and the first transfer device 22 to move towards the color filter substrate 01 to realize feeding of grinding cloth, such that the step of the color filter layer 03 is ground off; after the grinding operation is finished, in order to realize a spray-coating operation for the first film layer at a next step, both the grinding cloth 21 and the first transfer device 22 can be lifted to a certain height to reserve an enough space for the spray-coating operation.

In an embodiment of the present disclosure, the second transfer device 23 can include a guide rail 231 and a sliding support 232, the guide rail 231 is disposed along a direction vertical to the substrate, the sliding support 232 is matched and connected with the guide rail 231, and the sliding support 232 is connected to a driving component which can drive the sliding support 232 to slide along the slide rail; the grinding cloth 21 and the first transfer device 22 are disposed on the sliding support 232, such that the driving component drives the grinding cloth 21 and the first transfer device 22 to slide along the slide rail, and hence driving the grinding cloth 21 and the first transfer device 22 slide along a direction perpendicular to the substrate.

The driving component can include a screw rod and a screw nut matched with each other, the screw rod is disposed in parallel with the guide rail 231, and the screw nut is connected to the sliding support 232; the screw rod is connected to a rotary motor, which can drive the screw rod to rotate around an axis thereof such that the screw nut on the screw rod is driven to move up and down, and which can further drive the sliding support 232 connected to the screw nut to move up and down to realize up-down movement of the sliding support 232 relative to the guide rail 231.

The optical measuring system 31 is configured to measure profile characters of a surface of the color filter layer 03; for example, the optical measuring system 31 can be a three-dimensional profilometer.

At least one embodiment of the present disclosure provides a coating method for a color filter substrate, including steps of: measuring, by a detection control unit 3, a height of a step formed by a color filter layer 03 covering a black matrix to obtain the height of the step, and controlling the grinding device 2 to grind the color filter substrate 03 at a grinding amount according to the height of the step; and after the grinding device 2 finishes grinding, coating a first film layer on the color filter layer 03 of the substrate by operating a coating sprayer 1.

In the coating method for a color filter substrate according to an embodiment of the present disclosure, the detection control unit 3 firstly measures a height of a step formed by a color filter layer 03 covering a black matrix to obtain the height of the step, determines a grinding amount of the grinding device 2 according to the height of the step, and then controls the grinding device 2 to grind the color filter layer 03 to eliminate the step of the color filter layer 03, and finally controls and operates the coating sprayer 1 to coat a first film layer on a substrate 01 to finish the coating operation of the first film layer of the color filter substrate. Compared with the prior art, by adopting the coating apparatus for a color filter substrate according to the embodiments of the present disclosure to coat the first film layer on the substrate, the step of the color filter layer can be removed, the flatness of the color filter substrate can be improved, a height of the color filter layer can be reduced by removing the step of the color filter layer, and a coating thickness of the first film layer is reduced, thus saving a consumption amount of the material for the first film layer and reducing a cost for coating the first film layer.

In the embodiments above, measuring, by the detection control unit 3, a height of step formed by a color filter layer 03 covering a black matrix to obtain the height of the step, includes: scanning and photographing, by an optical measuring system 31, the color filter substrate to obtain an overall profile of the color filter layer 03; and obtaining, by a control unit 32, an average value of steps of the color filter layer 03 according to the overall profile of the color filter layer 03 so as to obtain a grinding amount for the step of the color filter layer 03. Values of the steps at respective points on the color filter substrate 03 are not the same, thus in order to obtain a proper grinding amount, in an embodiment of the present disclosure, an average value of the steps at respective points on every color filter layer 03 is calculated to ensure that the grinding device 2 can grind off most of the steps of the color filter layer 03.

The foregoing are merely specific embodiments of the invention, but not limitative to the protection scope of the present disclosure. Therefore, the protection scope of the invention should be defined by the accompanying claims.

The present disclosure claims the benefits of Chinese patent application No. 201510574035.0, which was filed on Sep. 10, 2015 and is fully incorporated herein by reference as part of this application.

1. A coating apparatus for a color filter substrate, comprising:
a coating sprayer configured to coat a first film layer on a color filter layer of the color filter substrate;
a grinding device configured to grind the color filter layer to eliminate a step formed by the color filter layer covering a black matrix; and
a detection control unit configured to measure a height of the step, determine a grinding amount of the grinding device according to the height of the step, and control an operation of the grinding device such that the first film layer coated on the color filter layer has a flat surface.

2. The coating apparatus for a color filter substrate according to claim 1, wherein the first film layer is a planarization layer or an alignment film layer.

3. The coating apparatus for a color filter substrate according to claim 1, wherein the detection control device comprises:
an optical measuring system configured to scan and photograph the color filter substrate to obtain an overall profile of the color filter layer; and
a control unit connected to the grinding device and the optical measuring system respectively, and configured to obtain an average value of steps of the color filter layer according to the overall profile of the color filter layer and determine a grinding amount of the grinding device according to the average value of the steps of the color filter layer.

4. The coating apparatus for a color filter substrate according to claim 1, wherein the grinding device comprises a grinding cloth and a first transfer device, and
the first transfer device is configured to drive the grinding cloth to move along a direction parallel with a base substrate of the color filter substrate.

5. The coating apparatus for a color filter substrate according to claim 4, wherein
the first transfer device comprises at least two transfer shafts disposed in parallel,
the grinding cloth is connected, end to end, to form an annular structure, and the grinding cloth with the annular structure is sleeved on the at least two transfer shafts and is tensioned by the transfer shafts such that one surface of the grinding cloth facing the base substrate is parallel with the base substrate; and
at least one of the transfer shafts is connected to a rotary motor, and the rotary motor is configured to drive the transfer shaft to rotate around axis thereof to drive the grinding cloth to move.

6. The coating apparatus for a color filter substrate according to claim 4, wherein the grinding device further comprises a second transfer device, and the second transfer device is capable of driving the grinding cloth and the first transfer device to move along a direction perpendicular to the base substrate.

7. The coating apparatus for a color filter substrate according to claim 6, wherein the second transfer device comprises a guide rail and a sliding support,
the guide rail is disposed along a direction perpendicular to the substrate,
the sliding support is provided with the grinding cloth and the first transfer device, and the sliding support is matched with and connected to the guide rail and is movable along the guide rail.

8. The coating apparatus for a color filter substrate according to claim 7, wherein the sliding support is connected to a driving component,
the driving component comprises a screw rod and a screw nut matched with each other, the screw nut is connected to the sliding support, the screw rod is disposed in parallel with the guide rail and is connected to a motor which drives the screw rod to rotate.

9. The coating apparatus for a color filter substrate according to claim 1, wherein the optical measuring system is a three-dimensional profilometer.

10. A coating method for a color filter substrate, comprising:
measuring, by a detection control unit, a height of a step formed by a color filter layer formed on the color filter substrate covering a black matrix to obtain the height of the step, determining a grinding amount for the color filter layer according to the height of the step, and grinding the color filter layer at the grinding amount; and
coating a first film layer on the color filter layer upon grinding.

11. The method according to claim 10, wherein measuring, by a detection control unit, a height of a step formed by a color filter layer on the color filter substrate covering a black matrix to obtain the height of the step, comprises:
scanning and photographing the color filter substrate to obtain an overall profile of the color filter layer; and
obtaining an average value of steps of the color filter layer according to the overall profile of the color filter layer.

12. The coating apparatus for a color filter substrate according to claim 3, wherein the grinding device comprises a grinding cloth and a first transfer device, and
the first transfer device is configured to drive the grinding cloth to move along a direction parallel with a base substrate of the color filter substrate.

13. The coating apparatus for a color filter substrate according to claim 12, wherein the first transfer device comprises at least two transfer shafts disposed in parallel, the grinding cloth is connected, end to end, to form an annular structure, and the grinding cloth with the annular structure is sleeved on the at least two transfer shafts and is tensioned by the transfer shafts such that one surface of the grinding cloth facing the base substrate is parallel with the base substrate; and
at least one of the transfer shafts is connected to a rotary motor, and the rotary motor is configured to drive the transfer shafts to rotate around axes thereof to drive the grinding cloth to move.

14. The coating apparatus for a color filter substrate according to claim 5, wherein the grinding device further comprises a second transfer device, and the second transfer device is capable of driving the grinding cloth and the first transfer device to move along a direction perpendicular to the base substrate.

15. The coating apparatus for a color filter substrate according to claim 13, wherein the grinding device further comprises a second transfer device, and the second transfer device is capable of driving the grinding cloth and the first transfer device to move along a direction perpendicular to the base substrate.
